(19) United States
(12) Patent Application Publication
(10) Pub. No.: US 2019/0092241 A1
(43) Pub. Date: Mar. 28, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Suguru FUJISAKI, Aichi (JP); Shigeki YOSHIDA, Aichi (JP)

(21) Appl. No.: 16/085,633

(22) PCT Filed: Mar. 23, 2017
(86) PCT No.: PCT/JP2017/011814

§ 371 Date: Sep. 17, 2018

(30) Foreign Application Priority Data
Apr. 8, 2016 (JP) 2016-078328

(51) Int. Cl. B60R 1/07

(52) U.S. Cl. CPC B60R 1/07; F16D 11/14

(57) ABSTRACT

A mutually contacting support face of a case (swing body) and supported face of a gear plate slope toward an upper side, this being one axial direction side of a support shaft, on progression toward the axial center of the support shaft. Accordingly, when the gear plate receives drive force from a motor in a state in which the gear plate is engaged with a clutch plate, if the gear plate attempts to move in a radial direction while receiving rotation force in a circumferential direction, the sloping supported face of the gear plate receives a reaction force from the sloping support face of the case, such that the gear plate is suppressed from moving in the radial direction.

### TECHNICAL FIELD

The present invention relates to a viewing device for vehicle in which a visual recognition section assists visual recognition by a vehicle occupant.

### BACKGROUND ART

Japanese Patent Application Laid-Open (JP-A) No. 2001-287593 discloses a vehicle door mirror structure. In this door mirror structure, a frame (swing body) is installed to a shaft (support shaft) so as to be capable of swinging about the shaft, and a final stage gear (gear), a plate clutch (clutch), a coil spring (urging member), and so on are inserted through the shaft.

In this structure, during normal operation in which external force is not applied, the final stage gear and the plate clutch are fitted together with each other by urging force from the coil spring. In this state, when the final stage gear receives rotation force from a motor (drive section) via an orbiting gear retained by the frame, the orbiting gear orbits the final stage gear, and the frame that retains the orbiting gear swings about the shaft.

However, if a specific external force is applied to a mirror body while the motor is in an inactive state, the final stage gear that is meshed with the orbiting gear attempts to swing about the shaft together with the frame. Swinging force of the final stage gear pushes the plate clutch upward against the urging force of the coil spring, separating the final stage gear and the plate clutch that were previously fitted together. The final stage gear thereby swings about the shaft, and the mirror body also swings, thereby providing a release for the external force.

SUMMARY OF INVENTION

### Technical Problem

However in this technology, the above operation is achieved by setting a slight gap between an outer peripheral side of the shaft and an inner peripheral side of an installation portion of the frame, and also setting a slight gap between the outer peripheral side of the shaft and an inner peripheral side of the final stage gear. There is accordingly a possibility that at least one out of an axial center of the final stage gear and a swing axial center of the frame might become offset from an axial center of the shaft.

In consideration of the above circumstances, an object of the present invention is to obtain a viewing device for vehicle capable of suppressing at least one out of an axial center of a gear and a swing axial center of a swing body from becoming offset from an axial center of a support shaft.

### Solution to Problem

A viewing device for vehicle of a first aspect of the present disclosure includes a support body, a swing body, a drive section, a gear, and a sloped face. The support body is provided on a vehicle body side and is provided with an upright support shaft. The swing body is capable of swinging about the support shaft, is supported from a lower side by the support body, and is provided with a visual recognition section to assist visual recognition by a vehicle occupant. The drive section is capable of outputting drive force. The gear is capable of rotating about the support shaft while having a restricted rotation about the support shaft, and is contacted and supported from the lower side by the swing body, the restricted rotation being maintained when the gear receives drive force from the drive section while restricted from rotating about the support shaft, such that drive force from the drive section is caused to act on the swing body as a swinging force. The sloped face is provided to at least one out of mutually contacting portions of the swing body and the gear, and slopes toward one axial direction side of the support shaft on progression toward an axial center of the support shaft.

In the viewing device for vehicle of the first aspect of the present disclosure, the support body is provided on the vehicle body side, and the swing body that is supported from the lower side by the support body is capable of swinging about the upright support shaft provided to the support body. The visual recognition section provided to the swing body assists visual recognition by the vehicle occupant. The gear is capable of rotating about the support shaft while having a restricted rotation about the support shaft, and is contacted and supported from the lower side by the swing body. The restricted rotation of the gear is maintained when the gear receives drive force from the drive section while rotation of the gear about the support shaft is restricted, such that drive force from the drive section is caused to act on the swing body as a swinging force.

The sloped face is provided to at least one out of mutually contacting portions of the swing body and the gear, and slopes toward one axial direction side of the support shaft on progression toward the axial center of the support shaft. Accordingly, if the gear attempts to move in a radial direction while receiving drive force from the drive section while rotation of the gear about the support shaft is being restricted, the gear receives a reaction force from the swing body as a result of providing the sloped face, such that the gear is suppressed from moving in the radial direction.

A viewing device for vehicle of a second aspect of the present disclosure includes a support body, a swing body, and a sloped face portion. The support body is provided on a vehicle body side and is provided with an upright support shaft. The swing body is capable of swinging about the support shaft, is contacted and supported from a lower side by the support body, and is provided with a visual recognition section to assist visual recognition by a vehicle occupant. The sloped face portion is provided to at least one out of mutually contacting portions of the support body and the swing body, and slopes toward one axial direction side of the support shaft on progression toward an axial center of the support shaft.

In the viewing device for vehicle of the second aspect of the present disclosure, the support body is provided on the vehicle body side, and the swing body that is contacted and supported from the lower side by the support body is capable of swinging about the upright support shaft provided to the support body. The visual recognition section provided to the swing body assists visual recognition by a vehicle occupant.

The sloped face portion is provided to at least one out of mutually contacting portions of the support body and the swing body, and slopes toward the one axial direction side of the support shaft on progression toward the axial center of the support shaft. Accordingly, if the swing body attempts to move in a swing-radial direction, the swing body receives a reaction force from the support body as a result of providing the sloped face portion, such that the gear is suppressed from moving in the swing-radial direction.

A viewing device for vehicle of a third aspect of the present disclosure is the configuration of the first aspect, wherein the swing body is contacted and supported from the lower side by the support body. Moreover, a sloped face portion that slopes toward the one axial direction side of the support shaft on progression toward the axial center of the support shaft is provided to at least one out of mutually contacting portions of the support body and the swing body.

In the viewing device for vehicle of the third aspect of the present disclosure, if the swing body attempts to move in a swing-radial direction, the swing body receives a reaction force from the support body as a result of providing the sloped face portion, such that the gear is suppressed from moving in the swing-radial direction.

A viewing device for vehicle of a fourth aspect of the present disclosure is the configuration of the first aspect or the third aspect, further including a clutch and an urging member. The clutch is penetrated by the support shaft, is provided at an upper side of the gear, is not able to rotate about the support shaft and is capable of moving along the axial direction of the support shaft, and is capable of engaging with the gear. The urging member is provided around the support shaft at an upper side of the clutch, and urges the clutch toward the lower side so as to cause the clutch to contact the gear. Moreover, at least one out of mutually contacting portions of the gear and the clutch is provided with a sloped face location that slopes toward another axial direction side of the support shaft on progression toward the axial center of the support shaft.

In the viewing device for vehicle of the fourth aspect of the present disclosure, the clutch that is penetrated by the support shaft is not able to rotate about the support shaft, is capable of moving along the axial direction of the support shaft, and is capable of engaging with the gear. The urging member urges the clutch toward the lower side so as to cause the clutch to contact the gear. The gear is accordingly capable of rotating about the support shaft while having a restricted rotation about the support shaft.

Note that at least one out of mutually contacting portions of the gear and the clutch is provided with the sloped face location that slopes toward the other axial direction side of the support shaft on progression toward the axial center of the support shaft. Namely, the sloped face provided to at least one out of the mutually contacting portions of the swing body and the gear and the sloped face location provided to at least one out of the mutually contacting portions of the gear and the clutch slope toward opposite sides to each other. Accordingly, when the gear receives drive force from the drive section in a state engaged with the clutch, the gear is further suppressed from moving in the radial direction.

A viewing device for vehicle of a fifth aspect of the present disclosure is the configuration of any one of the first aspect, the third aspect, or the fourth aspect, wherein a circular tube portion that projects out toward an upper side is formed to the swing body so as to run along an outer peripheral face of the support shaft, a recess that is recessed toward the upper side is formed in the gear so as to run along an outer peripheral face of the circular tube portion, and mutually contacting portions of the swing body and the gear are provided to a downward-facing bottom face of the recess and an upper face of the circular tube portion.

In the viewing device for vehicle of the fifth aspect of the present disclosure, the radius of a portion where the swing body and the gear slide over each other is suppressed, thereby suppressing overall friction resistance. Moreover, providing at least one out of these sliding portions with a sloped face enables the relative positions of the swing body and the gear to be further stabilized.

### Advantageous Effects of Invention

As described above, the viewing device for vehicle according to the present invention exhibits the excellent advantageous effect of enabling at least one out of the axial center of the gear and the swing axial center of the swing body to be suppressed from becoming offset from the axial center of the support shaft.

### BRIEF DESCRIPTION OF DRAWINGS

FIG. 1 is a face-on view illustrating a vehicle door mirror device according to a first exemplary embodiment of the present invention, in a state viewed from a vehicle rear side.

FIG. 2 is an exploded perspective view illustrating a stowing mechanism of the vehicle door mirror device in FIG. 1.

FIG. 3 is a cross-section of the stowing mechanism of the vehicle door mirror device in FIG. 1, in a state viewed from the vehicle rear side.

FIG. 4 is a cross-section taken along line 4-4 in FIG. 3.

FIG. 5 is a cross-section of a stowing mechanism of a vehicle door mirror device according to a second exemplary embodiment of the present invention, in a state viewed from the vehicle rear side.

FIG. 6A is a cross-section illustrating relevant portions of a modified example, in a state viewed from the vehicle rear side.

FIG. 6B is a cross-section illustrating relevant portions of a modified example, in a state viewed from the vehicle rear side.

FIG. 6C is a cross-section illustrating relevant portions of a modified example, in a state viewed from the vehicle rear side.

FIG. 6D is a cross-section illustrating relevant portions of a modified example, in a state viewed from the vehicle rear side.

FIG. 6E is a cross-section illustrating relevant portions of a modified example, in a state viewed from the vehicle rear side.

FIG. 6F is a cross-section illustrating relevant portions of a modified example, in a state viewed from the vehicle rear side.

### DESCRIPTION OF EMBODIMENTS

### First Exemplary Embodiment

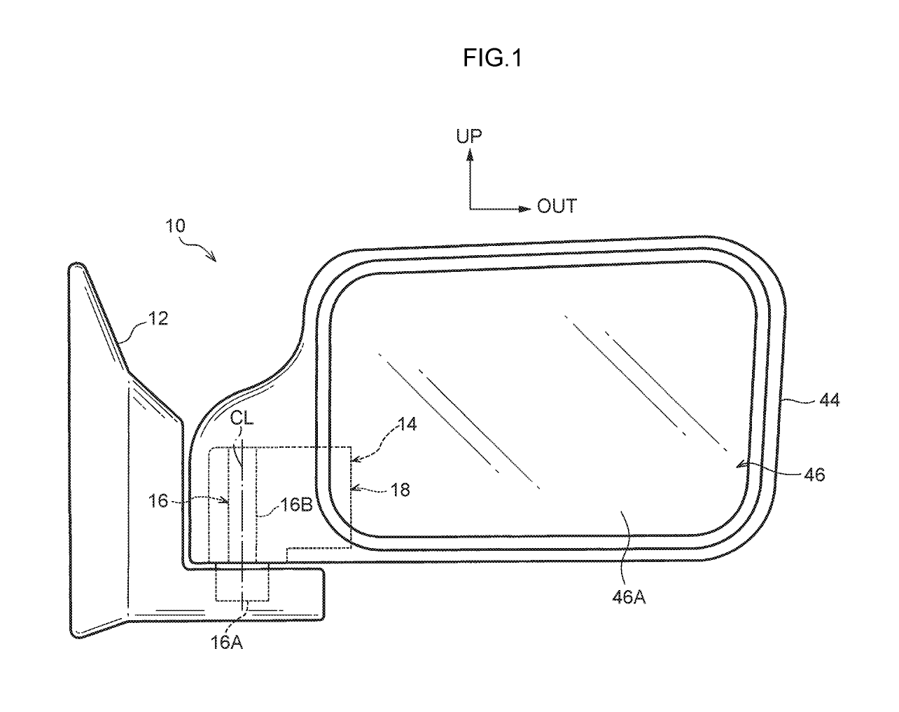

Explanation follows regarding a vehicle door mirror device serving as a viewing device for vehicle according to a first exemplary embodiment of the present invention, with reference to FIG. 1 to FIG. 4. Note that in these drawings, the arrow FR indicates a vehicle front side, the arrow UP indicates a vehicle upper side, and the arrow OUT indicates a vehicle width direction outside, as appropriate.

FIG. 1 is a face-on view illustrating a vehicle door mirror device 10 according to the present exemplary embodiment, in a state viewed from the vehicle rear side. The vehicle door mirror device 10 according to the present exemplary embodiment is provided to an up-down direction intermediate portion at a vehicle front side end of a side door (specifically, a front side door), serving as a vehicle door, and is disposed at the vehicle exterior.

As illustrated in FIG. 1, the vehicle door mirror device 10 includes a stay 12 (installation member). The vehicle door mirror device 10 is installed to the side door (vehicle body side) by fixing a vehicle width direction inside end of the stay 12 to the side door. A stowing mechanism 14 (also referred to as a swing mechanism, an electrical stowing mechanism, an electrical stowing unit, or a retractor) is supported at the upper side of a vehicle width direction outside portion of the stay 12.

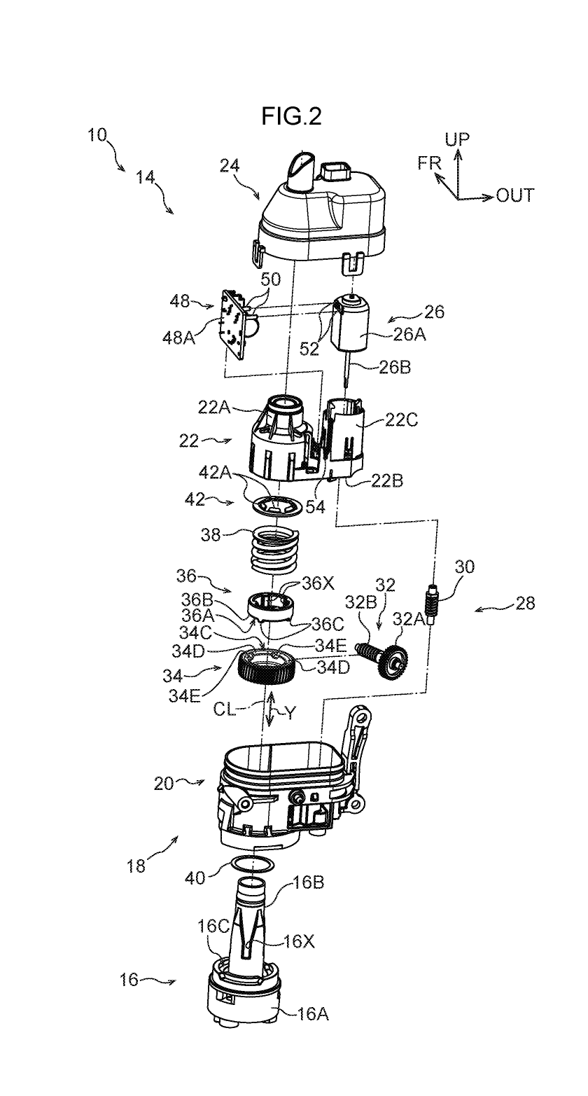

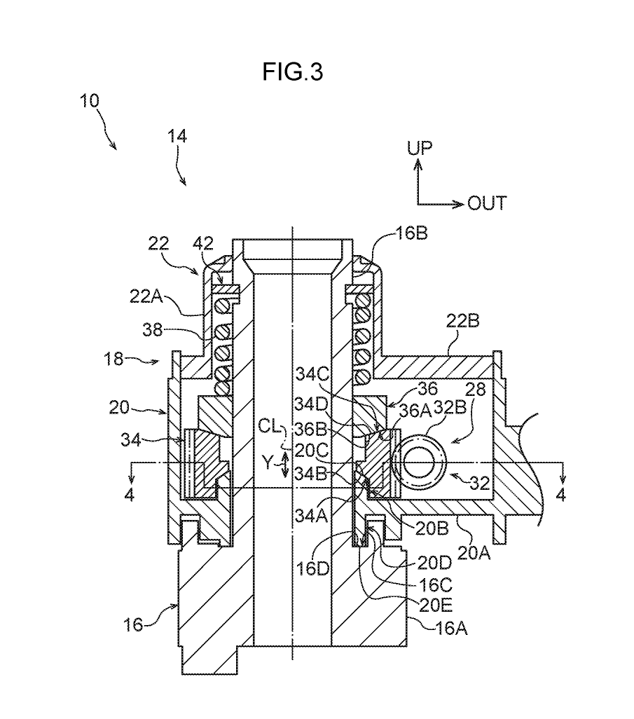

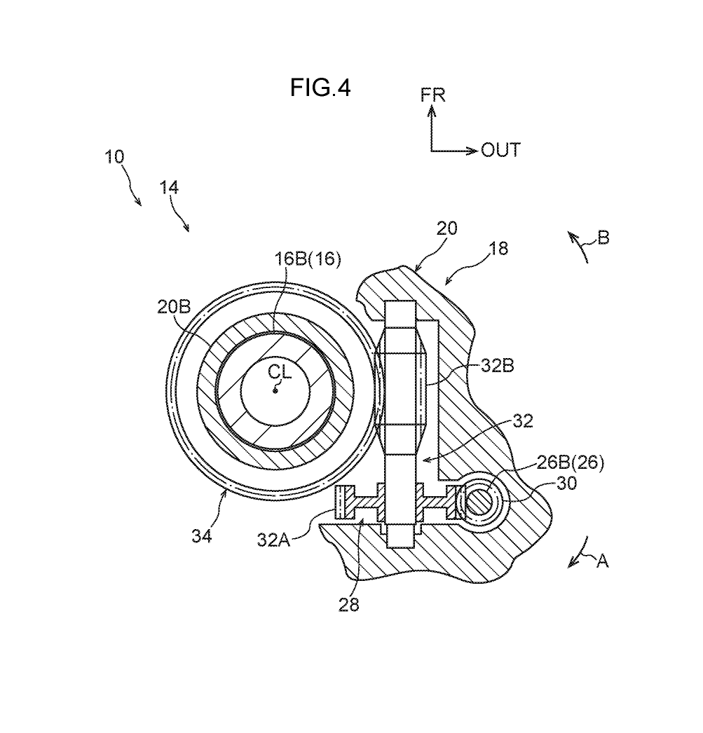

FIG. 2 is an exploded perspective view of the stowing mechanism 14, FIG. 3 is a cross-section of the stowing mechanism 14 in a state viewed from the vehicle rear side, and FIG. 4 is a cross-section taken along line 4-4 in FIG. 3.

A stand 16, serving as a support body on the side door (vehicle body side), is provided to the stowing mechanism 14 as illustrated in FIG. 2 to FIG. 4. A fixing portion 16A is provided at a lower portion of the stand 16. As illustrated in FIG. 1, the fixing portion 16A is fixed to the stay 12, thereby fixing the stand 16 to the stay 12 such that the stowing mechanism 14 is supported by the stay 12. A substantially circular cylinder shaped support shaft 16B is integrally provided projecting upward from the upper side of the fixing portion 16A. The axial direction of the support shaft 16B is disposed so as to run along the up-down direction.

As illustrated in FIG. 2, grooves 16X extending along the axial direction of the support shaft 16B are formed in an up-down direction intermediate portion of an outer circumferential portion of the support shaft 16B. Plural grooves 16X are formed in the outer circumferential portion of the support shaft 16B at uniform spacings around the circumferential direction. The grooves 16X each form a recess toward the radial direction inside of the support shaft 16B and are open toward the upper side.

As illustrated in FIG. 2 and FIG. 3, a ring-shaped recess 16C is provided to a lower portion of the stand 16 so as to encircle a lower end portion of the support shaft 16B. As illustrated in FIG. 2, a slip washer 40 is provided in the ring-shaped recess 16C. Note that the slip washer 40 is omitted from illustration in FIG. 3, which illustrates the ring-shaped recess 16C as a portion configured incorporating the slip washer 40. Grease is applied to a support face portion 16D configuring a bottom face of the ring-shaped recess 16C.

A swing body 18 is capable of swinging about the support shaft 16B. The swing body 18 is supported from the lower side by the stand 16.

As illustrated in FIG. 2 and FIG. 3, a container-shaped resin case 20 (swing member) is provided at a lower portion of the swing body 18. The upper side of the case 20 is open. As illustrated in FIG. 3, a circular tube portion 20B is formed at a vehicle width direction inside portion of a lower wall 20A of the case 20 configuring part of the swing body 18. The circular tube portion 20B projects toward the upper side so as to run along an outer circumferential face of the support shaft 16B of the stand 16. The support shaft 16B of the stand 16 passes through an axial center portion of the circular tube portion 20B of the case 20.

A cylindrical supported tube portion 20D is formed projecting toward the lower side from the lower side of the circular tube portion 20B of the case 20. A downward-facing supported face portion 20E is formed at a leading end (lower end) of the supported tube portion 20D. The supported face portion 20E of the case 20 is supported (contacted) from the lower side by the support face portion 16D of the ring-shaped recess 16C of the stand 16 in a state of face-on-face contact. The supported face portion 20E of the case 20 is supported by the support face portion 16D of the stand 16 so as to be capable swinging about the support shaft 16B. Namely, the supported face portion 20E and the support face portion 16D configure sliding faces that slide relative to each other.

A resin motor base 22 (assembly member) is fixed inside an upper portion of the case 20. A substantially circular cylinder shaped housing tube 22A is provided to a vehicle width direction inside portion of the motor base 22. The support shaft 16B of the stand 16 is coaxially housed inside the housing tube 22A. A substantially rectangular plate shaped bottom wall 22B is provided to a vehicle width direction outside portion of the motor base 22. The bottom wall 22B is integrally formed to a lower end portion of the housing tube 22A. As illustrated in FIG. 2, a substantially elliptical tube-shaped assembly tube 22C is integrally provided to an upper face of the bottom wall 22B. The assembly tube 22C is formed projecting out from the bottom wall 22B toward the upper side.

A container-shaped resin cover 24 (covering member) is provided at the upper side of the case 20 and the motor base 22. The lower side of the cover 24 is open. A lower end of the cover 24 is fixed to an outer periphery of an upper end portion of the case 20. The cover 24 covers the case 20 and the motor base 22 from the upper side.

A motor 26, serving as a drive section capable of outputting drive force, is provided inside the stowing mechanism 14. A substantially elliptical column shaped body 26A is provided to the motor 26. The body 26A of the motor 26 is assembled inside the assembly tube 22C of the motor base 22 from the upper side and fixed thereto. A metal output shaft 26B (motor shaft) extends coaxially from the body 26A of the motor 26. The output shaft 26B is disposed such that its axial direction runs along the up-down direction, and the output shaft 26B passes through the bottom wall 22B of the motor base 22 and extends to the lower side of the motor base 22. When the motor 26 is driven, the output shaft 26B rotates, thereby operating the stowing mechanism 14. Namely, the swing body 18 is swung by driving the motor 26 (explained in detail later).

A circuit board 48 is connected to the body 26A of the motor 26. A board body 48A is provided to the circuit board 48. A pair of terminals 50 are provided to an upper portion of the circuit board 48. The pair of terminals 50 extend from the board body 48A toward the vehicle width direction outside.

A pair of insertion ports 52 are provided at an upper portion of a vehicle width direction inside face of the body 26A of the motor 26. The pair of terminals 50 of the circuit board 48 are respectively inserted into the pair of insertion ports 52, such that the motor 26 and the circuit board 48 are electrically connected together. A lower end of the circuit board 48 is inserted into and supported by a groove 54 formed in the motor base 22. The circuit board 48 is thereby assembled at the vehicle width direction inside of the motor 26.

The circuit board 48 is electrically connected to a controller (not illustrated in the drawings) of the vehicle through a set of harnesses or the like (not illustrated in the drawings). Power is supplied to the motor 26 and the motor 26 is driven under the control of the controller, thereby rotating the output shaft 26B of the motor 26.

As illustrated in FIG. 2 to FIG. 4, a gear mechanism 28 is provided inside the case 20.

As illustrated in FIG. 2 and FIG. 4, the gear mechanism 28 is provided with a resin worm gear 30, serving as a first stage gear, at the lower side of the motor 26. The worm gear 30 is disposed with its axial direction along the up-down direction, and a lower portion of the worm gear 30 is supported by the lower wall 20A of the case 20 (see FIG. 3) so as to be capable of rotating. The output shaft 26B of the motor 26 is coaxially inserted into the worm gear 30 from the upper side. When the output shaft 26B rotates, the worm gear 30 rotates as a unit with the output shaft 26B.

The gear mechanism 28 is also provided with a worm shaft 32, serving as an intermediate gear, at the vehicle width direction inside of the worm gear 30. The axial direction of the worm shaft 32 is disposed extending along a horizontal direction, and the worm shaft 32 is supported by the case 20 so as to be capable of rotating. A resin helical gear 32A is coaxially provided to one end side portion (vehicle rear side portion) of the worm shaft 32, and a metal worm gear 32B is coaxially provided to another end side portion (vehicle front side portion) of the worm shaft 32. The helical gear 32A is meshed with the worm gear 30. When the worm gear 30 rotates, the helical gear 32A and the worm gear 32B rotate as a unit therewith, and the worm shaft 32 rotates.

The gear mechanism 28 is also provided with a metal gear plate 34 (worm wheel), serving as a gear, at the vehicle width direction inside of the worm shaft 32. The gear plate 34 is a member with an outer circumferential face that receives drive force from the motor 26 through the worm shaft 32 and so on, and is provided around the support shaft 16B. The support shaft 16B of the stand 16 passes coaxially through the gear plate 34, and the gear plate 34 is capable of rotating about the support shaft 16B. Note that in the drawings, the rotation axial center (rotation axis) of the gear plate 34, the swing axial center (swing axis) of the circular tube portion 20B of the case 20, and the axial center of the support shaft 16B of the stand 16 are indicated by the same single-dotted dashed line CL for convenience.

As illustrated in FIG. 3, a recess 34A that is recessed toward the upper side and encircles an outer circumferential face of the circular tube portion 20B of the case 20 (swing body 18) is formed in the gear plate 34. A supported face 34B is formed at a downward-facing bottom face of the recess 34A. The supported face 34B is supported (contacted) from the lower side by a support face 20C, configuring an upper face of the circular tube portion 20B of the case 20 (swing body 18), in a state of face-on-face contact. Namely, the supported face 34B and the support face 20C, these being mutually contacting portions of the case 20 (swing body 18) and the gear plate 34, configure sliding faces that slide relative to each other. The support face 20C and the supported face 34B form sloped faces that slope at a constant angle toward the upper side, this being one axial direction (arrow Y direction) side of the support shaft 16B, on progression toward the axial center CL of the support shaft 16B.

A ring-shaped upper face 34C of the gear plate 34 is formed with upper side contact faces 34D and detent recesses 34E (see FIG. 2). The upper side contact faces 34D make face-on-face contact with a clutch plate 36, serving as a clutch, described later, from the lower side. The detent recesses 34E serve as an engaged location. As illustrated in FIG. 2, the upper side contact faces 34D and the detent recesses 34E (four of each being formed in the present exemplary embodiment as an example) are formed alternately around the ring-shaped upper face 34C of the gear plate 34.

The plural detent recesses 34E are disposed at uniform spacings around the circumferential direction of the gear plate 34. A vertical cross-section profile of each detent recess 34E taken around the circumferential direction of the gear plate 34 forms an inverted trapezoidal shape set with a longer dimension at an upper end opening than at the base. The detent recesses 34E each slope at a constant angle toward the lower side on progression toward the rotation axial center of the gear plate 34.

The clutch plate 36 (engagement member) is provided encircling the support shaft 16B at the upper side of the gear plate 34. The clutch plate 36 is made of metal and is formed in a substantially circular cylinder shape. The support shaft 16B of the stand 16 passes coaxially through the clutch plate 36. Protrusions 36X that extend along the axial direction of the clutch plate 36 and protrude toward the radial direction inside of the clutch plate 36 are formed to an inner circumferential side of the clutch plate 36. Plural of the protrusions 36X are formed to an inner circumferential portion of the clutch plate 36 at uniform spacings around the circumferential direction, and are fitted into the grooves 16X formed in the support shaft 16B of the stand 16. The clutch plate 36 is thereby rendered incapable of rotating about the support shaft 16B, and capable of moving along the axial direction of the support shaft 16B (up-down direction). Note that in the drawings, the axial center (axis) of the clutch plate 36 is indicated by the same single-dotted dashed line CL as the axial center of the support shaft 16B and so on for convenience.

The clutch plate 36 includes a lower face 36A disposed in a state of face-on-face contact with the upper side contact faces 34D of the gear plate 34. Lower side contact faces 36B that are normally (when a visor 44 (see FIG. 1) or the like is not being applied with an external force with a high load) in face-on-face contact with the upper side contact faces 34D of the gear plate 34 are formed to the lower face 36A of the clutch plate 36. Detent protrusions 36C, serving as engagement locations, are also formed to the lower face 36A. The lower side contact faces 36B and the detent protrusions 36C (four of each in the present exemplary embodiment as an example) are formed alternately around the ring-shaped lower face 36A of the clutch plate 36.

The plural detent protrusions 36C are disposed at uniform spacings around the circumferential direction of the clutch plate 36. A vertical cross-section profile of each detent protrusion 36C taken around the circumferential direction of the clutch plate 36 forms an inverted trapezoidal shape set with a longer dimension along an upper end side than along a lower end side. The detent protrusions 36C each slope at a constant angle toward the lower side on progression toward the axial center of the clutch plate 36. The cross-section profiles of the detent protrusions 36C of the clutch plate 36 are similar in shape to, but slightly smaller than, the cross-section profiles of the detent recesses 34E of the gear plate 34.

Namely, the detent protrusions 36C of the clutch plate 36 are capable of being inserted into the detent recesses 34E of the gear plate 34, and the detent recesses 34E of the gear plate 34 and the detent protrusions 36C of the clutch plate 36 are capable of engaging with each other. When the detent protrusions 36C of the clutch plate 36 have been inserted into the detent recesses 34E of the gear plate 34, the lower side contact faces 36B of the clutch plate 36 make face-on-face contact with the upper side contact faces 34D of the gear plate 34. The upper side contact faces 34D of the gear plate 34 and the lower side contact faces 36B of the clutch plate 36, these being mutually contacting portions of the gear plate 34 of the clutch plate 36 respectively, each form a sloped face location that slopes at a constant angle toward the lower side, this being the other axial direction (arrow Y direction) side of the support shaft 16B, on progression toward the axial center CL of the support shaft 16B.

A coil spring 38 (compression coil spring), serving as an urging member, is provided encircling the support shaft 16B at the upper side of the clutch plate 36. The coil spring 38 is formed in a helical shape and is made of metal. The support shaft 16B of the stand 16 is coaxially inserted inside the coil spring 38.

A substantially annular plate shaped bush nut 42 (anchor member) is provided at the upper side of the coil spring 38. The bush nut 42 includes plural anchor claws 42A that are anchored to the support shaft 16B of the stand 16 such that the bush nut 42 is coaxially fixed to the support shaft 16B of the stand 16. In a state in which the bush nut 42 is fixed to the support shaft 16B, the bush nut 42 pushes and compresses the coil spring 38 toward the lower side, such that the coil spring 38 urges the clutch plate 36 toward the lower side so as to contact the gear plate 34. A state in which the clutch plate 36 is engaged with the gear plate 34 and the detent protrusions 36C of the clutch plate 36 are inserted into the detent recesses 34E of the gear plate 34 is thereby maintained by the urging force of the coil spring 38, such that the clutch plate 36 and the like restrict rotation of the gear plate 34 about the support shaft 16B.

The worm gear 32B of the worm shaft 32 is meshed with the gear plate 34. Thus, when the worm gear 32B rotates, the worm gear 32B swings about the gear plate 34, such that the swing body 18 swings with respect to the gear plate 34 as a unit with the worm gear 32B. Namely, the restriction on the gear plate 34 rotating about the support shaft 16B is maintained when the gear plate 34 receives drive force from the motor 26 while rotation is being restricted, such that drive force from the motor 26 is caused to act on the swing body 18 as a swinging force.

As illustrated in FIG. 1, the swing body 18 is housed inside a vehicle width direction inside portion of the substantially rectangular container-shaped visor 44 (housing member). The visor 44 is open toward the vehicle rear side. A mirror 46, serving as a visual recognition section, is disposed inside the visor 44 in the vicinity of the opening. The mirror 46 is formed in a substantially rectangular plate shape, and the visor 44 covers the entire periphery and a vehicle front side face of the mirror 46.

The visor 44 and the mirror 46 are coupled to and supported by the swing body 18. The visor 44 and mirror 46 project out from the side door, and are unfolded (deployed) with respect to the side door together with the swing body 18. A mirror surface 46A of the mirror 46 faces toward the vehicle rear side. The mirror 46 enables a vehicle occupant (the driver in particular) to view behind the vehicle, thereby assisting visual recognition of the occupant. Moreover, the visor 44 and the mirror 46 are capable of swinging about the support shaft 16B of the stand 16 as a unit with the swing body 18.

Explanation follows regarding operation and advantageous effects of the above exemplary embodiment.

As illustrated in FIG. 3, in the stowing mechanism 14 of the vehicle door mirror device 10 of the present exemplary embodiment, the urging force of the coil spring 38 causes the detent protrusions 36C of the clutch plate 36 (see FIG. 2) to engage with the detent recesses 34E of the gear plate 34 (see FIG. 2). Thus, the gear plate 34 is restricted from rotating in a rearward folding direction (see the arrow A direction in FIG. 4) and in a forward folding direction (see the arrow B direction in FIG. 4) with respect to the clutch plate 36. The swing body 18, the visor 44, and the mirror 46 illustrated in FIG. 1 are thereby restricted from rotating in the rearward folding direction and the forward folding direction.

When the stowing mechanism 14 illustrated in FIG. 3 is operated such that the motor 26 illustrated in FIG. 2 is driven under the control of the controller (not illustrated in the drawings), the output shaft 26B of the motor 26 rotates. In the gear mechanism 28, the worm gear 30 rotates as a unit with the output shaft 26B, thereby rotating the worm shaft 32 (the helical gear 32A and the worm gear 32B) such that the worm gear 32B swings about the gear plate 34. The swing body 18, the visor 44, and the mirror 46 illustrated in FIG. 1 thereby swing about the gear plate 34 as a unit with the worm gear 32B illustrated in FIG. 2.

When the motor 26 is driven under the control of the controller (not illustrated in the drawings) such that the output shaft 26B of the motor 26 rotates in one direction, the worm gear 32B swings in the rearward folding direction about the gear plate 34, such that the swing body 18, the visor 44, and the mirror 46 illustrated in FIG. 1 swing in the rearward folding direction (toward the vehicle rear side and vehicle width direction inside). The swing body 18, the visor 44, and the mirror 46 are thereby stowed (stowed toward the rear) with respect to the side door, such that they no longer project out.

When the motor 26 illustrated in FIG. 2 is then driven under the control of the controller (not illustrated in the drawings) such that the output shaft 26B of the motor 26 rotates in the other direction, the worm gear 32B swings in the forward folding direction about the gear plate 34, such that the swing body 18, the visor 44, and the mirror 46 illustrated in FIG. 1 also swing in the forward folding direction (toward the vehicle front side and vehicle width direction outside). Thus, the swing body 18, the visor 44, and the mirror 46 are unfolded (returned) so as to project out from the side door.

If an external force with a large load acts on at least one out of the visor 44 or the mirror 46 in one out of the rearward folding direction or the forward folding direction, rotation force with a large load in the one out of the rearward folding direction or the forward folding direction is input to the gear plate 34 from the worm gear 32B of the swing body 18 illustrated in FIG. 3. When this occurs, the engagement between the detent protrusions 36C of the clutch plate 36 and the detent recesses 34E of the gear plate 34 as illustrated in FIG. 2 is released by the clutch plate 36 moving toward the upper side against the urging force of the coil spring 38. Since the upper side contact faces 34D of the gear plate 34 are then disposed at the lower side of the detent protrusions 36C of the clutch plate 36 as a result, the gear plate 34 is permitted to rotate with respect to the clutch plate 36 in the one out of the rearward folding direction or the forward folding direction. The swing body 18, the visor 44, and the mirror 46 illustrated in FIG. 1 are thereby permitted to swing in the one out of the rearward folding direction or the forward folding direction.

Then, when external force in the rearward folding direction or the forward folding direction acts on at least one out of the visor 44 or the mirror 46, or if the motor 26 illustrated in FIG. 2 is driven so as to rotate the worm gear 32B, rotation force in the rearward folding direction or the forward folding direction is input to the gear plate 34 from the worm gear 32B. When the gear plate 34 rotates in the rearward folding direction or the forward folding direction with respect to the clutch plate 36 as a result, the urging force of the coil spring 38 causes the detent protrusions 36C of the clutch plate 36 to engage with the detent recesses 34E of the gear plate 34 as they move toward the lower side. The gear plate 34 is restricted from rotating in the rearward folding direction and the forward folding direction with respect to the clutch plate 36 as a result, thereby also restricting the swing body 18, the visor 44, and the mirror 46 illustrated in FIG. 1 from rotating in the rearward folding direction and the forward folding direction.

As illustrated in FIG. 3, in the present exemplary embodiment the mutually contacting support face 20C of the case 20 (swing body 18) and the supported face 34B of the gear plate 34 slope toward the upper side, this being one axial direction (arrow Y direction) side of the support shaft 16B, on progression toward the axial center CL of the support shaft 16B. Thus, when the outer circumferential face of the gear plate 34 receives drive force from the motor 26 in a state in which the gear plate 34 has engaged with the clutch plate 36, if the gear plate 34 attempts to move in the radial direction while receiving rotation force in the circumferential direction, the sloping supported face 34B (sloped sliding face) of the gear plate 34 receives a reaction force from the sloping support face 20C (sloped sliding face) of the case 20 (swing body 18), such that the gear plate 34 is suppressed from moving in the radial direction (configuring a self-aligning function).

In the present exemplary embodiment, the circular tube portion 20B of the case 20, which encircles the outer circumferential face of the support shaft 16B, enters the recess 34A of the gear plate 34. The supported face 34B of the gear plate 34 is formed to the downward-facing bottom face of the recess 34A, and the support face 20C that supports the supported face 34B of the gear plate 34 is formed to the upper face of the circular tube portion 20B. The radius of a portion where the case 20 (swing body 18) and the gear plate 34 slide over each other is thereby suppressed, thereby suppressing overall friction resistance. Moreover, configuring these sliding portions as sloped faces enables a greater stabilization of the relative positions of the swing body 18 and the gear plate 34.

In the present exemplary embodiment, the mutually contacting upper side contact faces 34D of the gear plate 34 and lower side contact faces 36B of the clutch plate 36 slope toward the lower side, this being the other axial direction (arrow Y direction) side of the support shaft 16B, on progression toward the axial center CL of the support shaft 16B. Namely, the slope direction of the support face 20C of the case 20 (swing body 18) and the supported face 34B of the gear plate 34 is a reverse direction to the slope direction of the upper side contact faces 34D of the gear plate 34 and the lower side contact faces 36B of the clutch plate 36. This further suppresses the gear plate 34 from moving in the radial direction when the gear plate 34 receives drive force from the motor 26 while in a state engaged with the clutch plate 36.

As explained above, the vehicle door mirror device 10 according to the present exemplary embodiment enables the axial center of the gear plate 34 to be suppressed from becoming offset from the axial center CL of the support shaft 16B.

This accordingly achieves a stable meshing depth between the worm gear 32B of the worm shaft 32 and the gear plate 34, enabling operation during electric stowing to be stabilized. Since the axis of the swing body 18 is stable, gaps where members configuring styling portions of the vehicle door mirror device 10 meet each other can also be made more consistent.

### Second Exemplary Embodiment

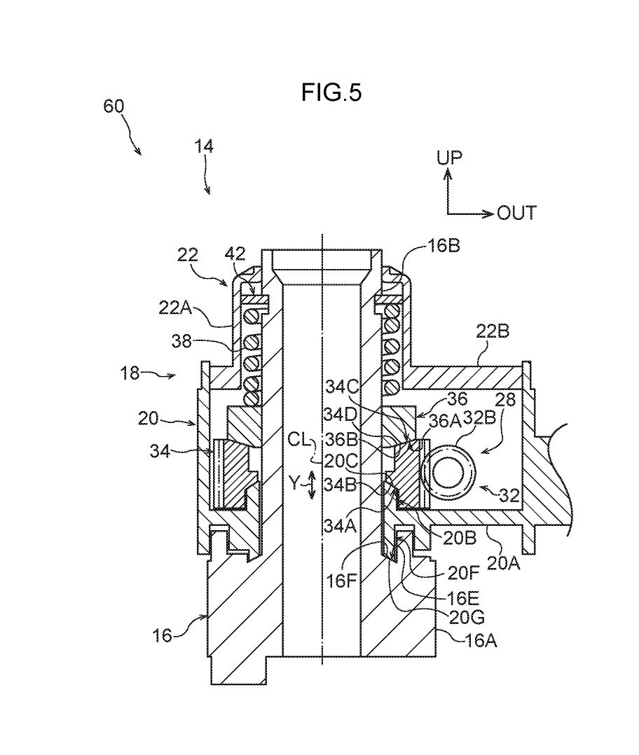

Explanation follows regarding a vehicle door mirror device serving as a viewing device for vehicle according to a second exemplary embodiment of the present invention, with reference to FIG. 5. FIG. 5 is a cross-section of a stowing mechanism of the vehicle door mirror device according to the present exemplary embodiment, in a state viewed from the vehicle rear side.

As illustrated in FIG. 5, a vehicle door mirror device 60 of the present exemplary embodiment differs from the first exemplary embodiment in that a supported face 20G of a supported tube portion 20F of the case 20, and a support face 16F configuring a bottom face of a ring-shaped recess 16E of the stand 16, are sloped. Other configuration is similar to the configuration of the first exemplary embodiment. Configuration portions that are basically the same as those in the first exemplary embodiment are thus appended with the same reference numerals, and explanation thereof is omitted.

The supported tube portion 20F of the case 20 is a configuration portion that is similar to the supported tube portion 20D of the case 20 of the first exemplary embodiment as illustrated in FIG. 3, with the exception that the supported face 20G configuring a lower face of the supported tube portion 20F is sloped. Moreover, the ring-shaped recess 16E of the stand 16 illustrated in FIG. 5 is a configuration portion that is similar to the ring-shaped recess 16C of the stand 16 of the first exemplary embodiment as illustrated in FIG. 3, with the exception that the support face 16F configuring the bottom face of the ring-shaped recess 16E is sloped.

As illustrated in FIG. 5, the supported face 20G of the supported tube portion 20F of the case 20 is supported (contacted) from the lower side by the support face 16F of the ring-shaped recess 16E of the stand 16 in a state of face-on-face contact. The support face 16F and the supported face 20G, these being mutually contacting portions of the stand 16 and the case 20 (swing body 18), configure sliding faces that slide relative to each other. The support face 16F and the supported face 20G configure sloped face portions that slope at a constant angle toward the upper side, this being one axial direction (arrow Y direction) side of the support shaft 16B, on progression toward the axial center CL of the support shaft 16B.

In the present exemplary embodiment, when the outer circumferential face of the gear plate 34 receives drive force from the motor 26 (see FIG. 2) while in a state engaged with the clutch plate 36, if the case 20 (swing body 18) attempts to move in a swing-radial direction while receiving rotation force in the circumferential direction, the sloping supported face 20G (sloped sliding face) of the case 20 (swing body 18) receives a reaction force from the sloping support face 16F (sloped sliding face) of the stand 16. The case 20 (swing body 18) is thereby suppressed from moving in the swing-radial direction (configuring a self-aligning function). This enables the axial center of the gear plate 34 and the swing axial center of the swing body 18 to be suppressed from becoming offset from the axial center CL of the support shaft 16B.

### Modified Example of Second Exemplary Embodiment

Note that as a modified example of the second exemplary embodiment, a modified example may be adopted in which respective mutually contacting portions of a case (20) (swing body) and a gear plate (34) serving as a gear are set so as to be perpendicular to the axial center CL of the support shaft 16B, with other configuration being similar to the configuration of the second exemplary embodiment.

In this modified example also, if the case (20) (swing body) attempts to move in the swing-radial direction while receiving rotation force in the circumferential direction, the supported face (20G) of the case (20) (swing body) receives a reaction force from the support face (16F) of the stand (16), such that the case (20) (swing body) is suppressed from moving in the swing-radial direction. This enables the swing center of the case (20) (swing body) to be suppressed from becoming offset from the axial center (CL) of the support shaft (16B).

### Other Modified Examples

Note that as a modified example of the first and second exemplary embodiments, respective mutually contacting faces (contacting portions) of a gear plate (34) serving as a gear and a clutch plate (36) serving as a clutch may be set so as to be perpendicular to an axial center (CL) of a support shaft (16B), or may be sloped toward the upper side on progression toward the axial center (CL) of the support shaft (16B).

As another modified example of the first and second exemplary embodiments, respective mutually contacting portions of a case (20) (swing body 18) and a gear plate (34) may be configured as sloped faces that slope toward the lower side, this being one axial direction (arrow Y direction) side of a support shaft (16B), on progression toward an axial center (CL) of the support shaft (16B). Namely, although the one axial direction (arrow Y direction) side of the support shaft (16B) corresponds to the upper side in the first and second exemplary embodiments, the one axial direction (arrow Y direction) side of the support shaft (16B) may correspond to the lower side in a modified example of the first and second exemplary embodiments. In such a configuration, respective mutually contacting faces (contacting portions) of the gear plate (34) serving as a gear and a clutch plate (36) serving as a clutch may be configured sloping toward the upper side, this being the other rotation-axis direction (arrow Y direction) side, on progression toward the axial center (CL) of the support shaft (16B). Namely, although the one axial direction (arrow Y direction) side of the support shaft (16B) is the upper side and the other axial direction (arrow Y direction) side of the support shaft (16B) is the lower side in the first and second exemplary embodiments, the one axial direction (arrow Y direction) side of the support shaft (16B) may be the lower side and the other axial direction (arrow Y direction) side of the support shaft (16B) may be the upper side in a modified example of the first and second exemplary embodiments.

As another modified example of the first and second exemplary embodiments, mutually contacting portions of a case (20) (swing body) and a gear plate (34) serving as a gear may be configured as faces with rotation symmetry, with an axial center (CL) of a support shaft (16B) as the line of symmetry, and may also be provided with sloped faces that slope while curving toward one axial direction (arrow Y direction) side of the support shaft (16B) on progression toward the axial center (CL) of the support shaft (16B). Similarly, mutually contacting portions of a gear plate (34) serving as a gear and a clutch plate (36) serving as a clutch may be configured as faces with rotation symmetry, with an axial center (CL) of a support shaft (16B) as the line of symmetry, and also be provided with sloped face locations that slope while curving toward one axial direction (arrow Y direction) side of the support shaft (16B) on progression toward the axial center (CL) of the support shaft (16B).

As another modified example of the second exemplary embodiment, respective mutually contacting portions of a stand (16) serving as a support body and a case (20) (swing body) may be configured as sloped face portions that slope toward the lower side, this being one axial direction (arrow Y direction) side of a support shaft (16B), on progression toward an axial center (CL) of the support shaft (16B).

As another modified example of the second exemplary embodiment, mutually contacting portions of a stand (16) serving as a support body and a case (20) (swing body) may be configured as faces with rotation symmetry, with an axial center (CL) of a support shaft (16B) as the line of symmetry, and also be provided with sloped face portions that slope while curving toward one axial direction (arrow Y direction) side of the support shaft (16B) on progression toward the axial center (CL) of the support shaft (16B).

In the above exemplary embodiments, the circular tube portion 20B is formed to the case 20 and the recess 34A is formed in the gear plate 34. However, as a modified example of the above exemplary embodiments, a configuration may be adopted in which the circular tube portion 20B and the recess 34A are not formed, and mutually contacting portions of a case (20) (swing body) and a gear plate (34) are provided with sloped faces that slope toward one axial direction (arrow Y direction) side of a support shaft (16B) on progression toward an axial center (CL) of the support shaft (16B).

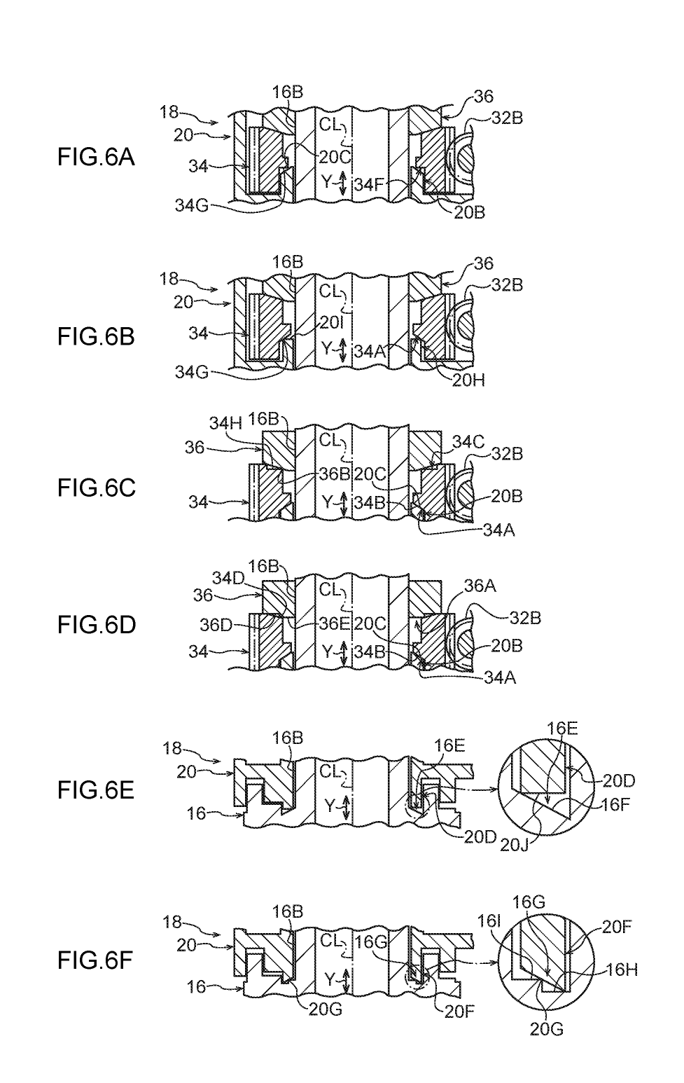

As illustrated in FIG. 3 and so on, in the above exemplary embodiments, sloped faces (support face 20C, supported face 34B) are respectively formed to the mutually contacting portions of both the case 20 (swing body 18) and the gear plate 34. However, as a modified example of the above exemplary embodiments, a configuration may be adopted in which only one out of mutually contacting portions of a case (20) (swing body 18) and a gear plate (34) is provided with a sloped face that slopes toward one axial direction (arrow Y direction) side of a support shaft (16B) on progression toward an axial center (CL) of the support shaft (16B). Examples of this are illustrated in FIG. 6A and FIG. 6B.

Namely, as illustrated in FIG. 6A, configuration may be such that, from out of the mutually contacting portions of the case 20 (swing body 18) and the gear plate 34, only the support face 20C of the case 20 (swing body 18) is provided with a sloped face that slopes toward one axial direction (arrow Y direction) side (the upper side in FIG. 6A) of the support shaft 16B on progression toward the axial center CL of the support shaft 16B. Note that in the modified example illustrated in FIG. 6A, a recess 34F that is recessed toward the upper side so as to encircle the outer circumferential face of the circular tube portion 20B of the case 20 is formed in the gear plate 34, and a downward-facing bottom face 34G of the recess 34F is set so as to be perpendicular to the axial center CL of the support shaft 16B. A radial direction inside end of the bottom face 34G of the gear plate 34 is contacted and supported from the lower side by the support face 20C of the case 20. In such a configuration also, if the gear plate 34 attempts to move in the radial direction while receiving rotation force in the circumferential direction, the radial direction inside end of the downward-facing bottom face 34G of the gear plate 34 receives a reaction force from the support face 20C of the case 20 (swing body 18), such that the gear plate 34 is suppressed from moving in the radial direction.

Alternatively, as illustrated in FIG. 6B, configuration may be such that, from out of the mutually contacting portions of the case 20 (swing body 18) and the gear plate 34, only the supported face 34B of the gear plate 34 is provided with a sloped face that slopes toward one axial direction (arrow Y direction) side (the upper side in FIG. 6B) of the support shaft 16B on progression toward the axial center CL of the support shaft 16B. Note that in the modified example illustrated in FIG. 6B, a circular tube portion 20H that projects out toward the upper side so as to encircle the outer circumferential face of the support shaft 16B is formed to the case 20, and an upper face 20I of the circular tube portion 20H is set so as to be perpendicular to the axial center CL of the support shaft 16B. The supported face 34B of the gear plate 34 is contacted and supported from the lower side by a swing-radial direction outside end of the upper face 20I of the case 20. In such a configuration also, if the gear plate 34 attempts to move in the radial direction while receiving rotation force in the circumferential direction, the supported face 34B of the gear plate 34 receives a reaction force from the swing-radial direction outside end of the upper face 20I of the case 20 (swing body 18), such that the gear plate 34 is suppressed from moving in the radial direction.

As illustrated in FIG. 3 and so on, in the above exemplary embodiments, sloped face locations (upper side contact faces 34D, lower side contact faces 36B) are respectively formed to both mutually contacting portions of the gear plate 34 and the clutch plate 36. However, as a modified example of the above exemplary embodiments, a configuration may be adopted in which only at least one out of mutually contacting portions of a gear plate (34) and a clutch plate (36) are provided with sloped face locations sloping toward the other axial direction (arrow Y direction) side of a support shaft (16B) on progression toward an axial center (CL) of the support shaft (16B). Examples of this are illustrated in FIG. 6C and FIG. 6D.

Namely, as illustrated in FIG. 6C, configuration may be such that, from out of the mutually contacting portions of the gear plate 34 and the clutch plate 36, only the lower side contact faces 36B of the clutch plate 36 are provided with sloped face locations sloping toward the other axial direction (arrow Y direction) side (the lower side in FIG. 6C) of the support shaft 16B on progression toward the axial center CL of the support shaft 16B. Note that in the modified example illustrated in FIG. 6C, an upper side recess 34H that is recessed toward the lower side is formed in the upper face 34C of the gear plate 34, and a radial direction inside end of a bottom face of the upper side recess 34H and an upper side opening end of the upper side recess 34H contact the lower side contact faces 36B of the clutch plate 36. In such a configuration also, if the gear plate 34 attempts to move in the radial direction while receiving rotation force in the circumferential direction, the radial direction inside end of the bottom face of the upper side recess 34H and the upper side opening end of the upper side recess 34H of the gear plate 34 receive a reaction force from the lower side contact faces 36B of the clutch plate 36, such that the gear plate 34 is suppressed from moving in the radial direction.

Alternatively, as illustrated in FIG. 6D, configuration may be such that, from out of the mutually contacting portions of the gear plate 34 and the clutch plate 36, only the upper side contact faces 34D of the gear plate 34 are provided with sloped face locations sloping toward the other axial direction (arrow Y direction) side (the lower side in FIG. 6D) of the support shaft 16B on progression toward the axial center CL of the support shaft 16B. Note that in the modified example illustrated in FIG. 6D, the lower face 36A of the clutch plate 36 includes a step structure in which an outside location 36D configuring the radial direction outside is recessed to form a step toward the upper side from an inside location 36E configuring the radial direction inside of the lower face 36A, and respective radial direction outside ends of the outside location 36D and the inside location 36E contact the upper side contact faces 34D of the gear plate 34. In such a configuration also, if the gear plate 34 attempts to move in the radial direction while receiving rotation force in the circumferential direction, the upper side contact faces 34D of the gear plate 34 receive a reaction force from the respective radial direction outside ends of the outside location 36D and the inside location 36E of the clutch plate 36, such that the gear plate 34 is suppressed from moving in the radial direction.

As illustrated in FIG. 5 and so on, in the second exemplary embodiment, sloped face portions (support face 16F, supported face 20G) are respectively formed to both mutually contacting portions of the stand 16 and the case 20 (swing body 18). However, as a modified example of the above exemplary embodiment, a configuration may be adopted in which only one out of mutually contacting portions of a stand (16) and a case (20) (swing body 18) is provided with a sloped face portion that slopes toward one axial direction (arrow Y direction) side of a support shaft (16B) on progression toward an axial center (CL) of the support shaft (16B). Examples of this are illustrated in FIG. 6E and FIG. 6F.

Namely, as illustrated in FIG. 6E, configuration may be such that, from out of the mutually contacting portions of the stand 16 and the case 20 (swing body 18), only the support face 16F of the stand 16 is provided with a sloped face portion that slopes toward one axial direction (arrow Y direction) side (the upper side in FIG. 6E) of the support shaft 16B on progression toward the axial center CL of the support shaft 16B. Note that in the modified example illustrated in FIG. 6E, a supported tube portion of the case 20 that is inserted into the ring-shaped recess 16E of the stand 16 has basically the same configuration as the supported tube portion 20D in the first exemplary embodiment, and so is appended with the same reference numeral 20D. A radial direction inside end of a lower face 20J of the supported tube portion 20D is contacted and supported from the lower side by the support face 16F of the stand 16. In such a configuration also, if the case 20 (swing body 18) attempts to move in the swing-radial direction while receiving rotation force in the circumferential direction, the radial direction inside end of the lower face 20J of the supported tube portion 20D of the case 20 (swing body 18) receives a reaction force from the support face 16F of the stand 16, such that the case 20 (swing body 18) is suppressed from moving in the swing-radial direction.

Alternatively, as illustrated in FIG. 6F, configuration may be such that, from out of the mutually contacting portions of the stand 16 and the case 20 (swing body 18), only the supported face 20G of the case 20 (swing body 18) is provided with a sloped face portion that slopes toward one axial direction (arrow Y direction) side (the upper side in FIG. 6F) of the support shaft 16B on progression toward the axial center CL of the support shaft 16B. Note that in the modified example illustrated in FIG. 6F, a bottom face of a ring-shaped recess 16G of the stand 16, into which the supported tube portion 20F of the case 20 is inserted, includes a step structure in which a bottom face outside portion 16H configuring the radial direction outside of the bottom face is recessed a to form a step toward the lower side from a bottom face inside portion 161 configuring the radial direction inside of the bottom face, as is clearly illustrated in the enlarged portion of FIG. 6E A radial direction outside end of the bottom face inside portion 161 contacts the supported face 20G of the case 20. In such a configuration also, if the case 20 (swing body 18) attempts to move in the swing-radial direction while receiving rotation force in the circumferential direction, the supported face 20G of the case 20 (swing body 18) receives a reaction force from the radial direction outside end of the bottom face inside portion 161 of the stand 16, such that the case 20 (swing body 18) is suppressed from moving in the swing-radial direction.

In the above exemplary embodiments, the viewing device for vehicle of the present invention is configured as the vehicle door mirror device 10, 60 illustrated in FIG. 1 and so on. However, the viewing device for vehicle of the present invention may be another viewing device for vehicle such as another vehicle mirror device, or a vehicle camera device. Note that examples of other vehicle mirror devices include a vehicle outer mirror device disposed at another location of a vehicle exterior section (such as a vehicle fender mirror device), or a vehicle inner mirror device disposed at a vehicle interior section. The vehicle camera device is a viewing device for vehicle including a camera serving as a visual recognition section that captures images in order to assist visual recognition by a vehicle occupant.

Note that the above exemplary embodiments and the plural modified examples described above may be implemented in appropriate combinations.

Examples of the present invention have been given above; however, the present invention is not limited to the above examples, and obviously various other modifications may be implemented within a range not departing from the spirit of the present invention.

The entire disclosure of Japanese Patent Application No. 2016-78328 filed Apr. 8, 2016 is incorporated by reference in this specification.

1. A viewing device for vehicle comprising:
a support body that is provided on a vehicle body side and that is provided with an upright support shaft;
a swing body that is capable of swinging about the support shaft, that is supported from a lower side by the support body, and that is provided with a visual recognition section to assist visual recognition by a vehicle occupant;
a drive section that is capable of outputting drive force;
a gear that is capable of rotating about the support shaft while having a restricted rotation about the support shaft, and that is contacted and supported from the lower side by the swing body, the restricted rotation being maintained when the gear receives drive force from the drive section while restricted from rotating about the support shaft, such that drive force from the drive section is caused to act on the swing body as a swinging force; and
a sloped face that is provided to at least one of mutually contacting portions of the swing body and the gear, and that slopes toward one axial direction side of the support shaft on progression toward an axial center of the support shaft.

2. A viewing device for vehicle comprising:
a support body that is provided on a vehicle body side and that is provided with an upright support shaft;
a swing body that is capable of swinging about the support shaft, that is contacted and supported from a lower side by the support body, and that is provided with a visual recognition section to assist visual recognition by a vehicle occupant; and
a sloped face portion that is provided to at least one of mutually contacting portions of the support body and the swing body, and that slopes toward one axial direction side of the support shaft on progression toward an axial center of the support shaft.

3. The viewing device for vehicle of claim 1, wherein:
the swing body is contacted and supported from the lower side by the support body; and
a sloped face portion that slopes toward the one axial direction side of the support shaft on progression toward the axial center of the support shaft is provided to at least one of mutually contacting portions of the support body and the swing body.

4. The viewing device for vehicle of claim 1, further comprising:
a clutch that is penetrated by the support shaft, that is provided at an upper side of the gear, that is not able to rotate about the support shaft and is capable of moving along the axial direction of the support shaft, and that is capable of engaging with the gear; and
an urging member that is provided around the support shaft at an upper side of the clutch, and that urges the clutch toward the lower side so as to cause the clutch to contact the gear,
at least one of mutually contacting portions of the gear and the clutch being provided with a sloped face location that slopes toward another axial direction side of the support shaft on progression toward the axial center of the support shaft.

5. The viewing device for vehicle of claim 1, wherein:
a circular tube portion that projects out toward an upper side is formed to the swing body so as to run along an outer peripheral face of the support shaft;
a recess that is recessed toward the upper side is formed in the gear so as to run along an outer peripheral face of the circular tube portion; and
mutually contacting portions of the swing body and the gear are provided to a downward-facing bottom face of the recess and an upper face of the circular tube portion.
